(19) United States
(12) Patent Application Publication
(10) Pub. No.: US 2006/0067549 A1
(43) Pub. Date: Mar. 30, 2006

(54) Method of operating a hearing aid system having at least two hearing aids

(75) Inventors: Henning Puder, Erlangen (DE); Andre Steinbuss, Numberg (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Audiologische Technik GmbH

(21) Appl. No.: 11/237,469

(22) Filed: Sep. 28, 2005

(30) Foreign Application Priority Data
Sep. 30, 2004 (DE) 10 2004 047 759.0

(51) Int. Cl. H04R 25/00

(52) U.S. Cl. 381/315; 381/312

(57) ABSTRACT

In a hearing aid the transmission and amplification of a useful signal is to be improved, especially in difficult environments, i.e. those susceptible to interference signals. To this end it is proposed that signals be transmitted between a first hearing aid worn by a first hearing aid wearer and a second hearing aid worn by a second hearing aid wearer. In this case the transmitted signals can consist of control parameters, sound field characteristic values or an audio signal. Further it is possible for the signal transmission between the first hearing aid and the second hearing aid to be under-taken via at least one further hearing aid which is worn by at least one further hearing aid wearer. The third hearing aid fulfills the function of a relay station in this case. Through the invention a signal with improved signal-to-noise ratio can be fed directly to the hearing of a hearing aid wearer or the signal processing of a hearing aid can be better adapted to the relevant environmental situation.

### CROSS REFERENCE TO RELATED APPLICATIONS

This application claims priority to the German application No. 10 2004 047 759.0, filed Sep. 30, 2004 which is incorporated by reference herein in its entirety.

### FIELD OF INVENTION

The invention relates to the use of a hearing aid system with at least a first hearing aid that can be worn on the head or body of a hearing aid wearer and a second hearing aid that can be worn on the head or body of a hearing aid wearer, comprising in each case at least one input converter to accept an input signal and convert it into an electrical input signal, a signal processing unit for processing and amplification of the electrical input signal and an output converter for emitting a signal which can b e perceived by the hearing aid wearer as an acoustic signal, with control parameters being transmitted from the first hearing aid to the second hearing aid for control of the signal processing in the second hearing aid.

### BACKGROUND OF INVENTION

In a hearing aid an input converter takes an input signal and converts it into an electrical input signal. Usually at least one microphone which accepts an acoustic input signal serves as an input converter. Modem hearing aids frequently comprise a microphone system with a number of microphones so as to achieve reception which depends on the direction of incidence of acoustic signals, a directional characteristic. The input converter can however also include a telephone loop or an antenna to accept electromagn etic input signals. The input signals converted by the input converter into electrical input signals are routed to a signal processing unit for further processing and amplification. The further processing and amplification is undertaken to compensate for the individual loss of hearing of a hearing aid wearer and is generally a function of the signal frequency. The signal processing unit emits an electrical output signal which is fed via an output converter to the hearing of the hearing aid wearer so that the wearer perceives the output signal as an acoustic signal. Earpieces which generate an acoustic output signal are usually used as output converters. However output converters to generate mechanical oscillations are also known, which directly excite specific parts of the hearing into oscillation, for example the small bones in the ear. Furthermore output converters are known which stimulate the direct nerve cells of the hearing.

The size of hearing aids is being reduced ever further in order to make them more acceptable to wear for patients. Thus, especially with adults, the trend is ever more away from behind the ear (BTE) devices and towards in-the-ear (ITE). What are known as CIC (Complete in Canal) hearing aids even fit entirely into the auditory canal.

Human hearing must be able to deal with very many basically different hearing situations. Examples of such hearing situations are: Quiet environment, conversation, television, car journey, telephony, party and so forth. Accordingly the transmission characteristics of hearing aids are to be adapted to the different situations. To this end a number of different hearing programs can be selected in the hearing aids. Usually these hearing programs can be selected by switches or buttons on the hearing aid itself or by using a remote control. To an increasing extent hearing aids are being used which automatically adapt the programs to suit different hearing environments. One of the reasons for this is to make wearing and using the hearing aid more convenient. Thus for example the hearing aid, if it registers a telephone loop signal, can switch automatically to a telephone hearing program or parameters influencing the signal processing in the hearing aid can be set automatically as a result of an analysis of an acoustic input signal. A further reason for the need for automatic adaptation to different hearing environments lies in the small size, particularly of CIC hearing aids. These types of small devices can no longer be operated manually in practical terms without the use of a remote control.

From EP 0 941 014 A2 a hearing aid system with two hearing aids is known, in which, by activating a control on one of the two hearing aids of the hearing aid system a control signal is created and is transmitted to the second hearing aid, which leads to a simultaneous adaptation of the two hearing aids by this control signal and the hearing aids' own signal processing units.

From DE 100 48 354 A1 a hearing aid system with at least two hearing aids is known, between which a signal path for wireless signal transmission is provided. The hearing aids each comprise a signal processing unit which is adapted to different hearing situations, in which case sound field characteristics are generated in the first hearing aid through analysis of an acoustic signal accepted by a microphone of the hearing aid and the sound field characteristics of the first hearing aid are transmitted to the second hearing aid of the hearing aid system for adapting the signal processing unit in the second hearing aid to the sound field on the basis of the characteristic values generated in the two hearing aids.

From U.S. Pat. No. 5,757,932 a hearing aid system with at least two hearing devices for binaural provision to a hearing aid wearer is known, in which there is provision for acoustic signals to be transmitted between the two devices.

### SUMMARY OF INVENTION

For an acoustic signal transmitted and amplified by means of a hearing aid the hearing aid wearer's ability to understand speech is very much adversely affected if the hearing aid wearer finds himself or herself in difficult acoustic situations, such as environments where echoes are produced or environments where a number of people are talking at the same time, known as the cocktail party situation. One known solution to this problem is to use a directional microphone or various interference noise reduction methods. In addition, especially for use in training rooms, the use of what are known as FM systems to assist the hard -of-hearing is known. In this case the acoustic signal is accepted by an external microphone and transmitted as an electromagnetic signal to the hearing aid.

An object of the present invention is to improve the transmission and amplification of a useful signal by means of a hearing aid, especially in difficult environments.

This object is achieved by the claims.

The basic idea of the invention is to provide a transmission of data between hearing aids of different hearing aid wearers. In this case wire less signal transmission is preferred, so that the different hearing aid wearers can move about freely in the room independently of each other. The hearing aids are equipped with the corresponding transmitters and receivers which are integrated directly into the hearing aid or can be embodied for example as external transceiver units which can be worn on the body. A hearing aid system used in accordance with the invention thus comprises at least two hearing aids which can be worn by different hearing aid wearers.

For adapting signal processing in the first hearing aid to the hearing environment obtaining at a particular point in time the control parameters which affect the signal processing are set for a hearing aid worn by a first hearing aid wearer. The control parameters can be set manually, e.g. by manual selection of a specific hearing program. Preferably however the control parameters are set automatically by an analysis of the input signal. In accordance with the invention control parameters can be transferred from the first hearing aid to a second hearing aid worn by a second hearing aid wearer for control of signal processing in the second hearing aid. The control parameters transmitted can for example relate to the hearing program set in the first hearing aid. However these can also be algorithmic estimated values, i.e. internal signal values, which must be estimated with knowledge of the input signal, e.g. classifier values, parameters of a scene analysis etc.

In another inventive use, sound field characteristic values rather than control parameters are transmitted from the first hearing aid to the second hearing aid. The sound field characteristic values are obtained by analyzing the input signal arriving at the first hearing aid. This includes especially characteristic values relating to the signal level, the frequency spectrum, the modulation frequency, the modulation depth, the noise components as well as spatial characteristic values of acoustic signals of the sound field. The spatial sound field characteristic values can for their part be subdivided into coherence, incident direction of interference signals, incident direction of the useful signal, etc. The sound field characteristic values form the database with reference to which the classifier in the hearing aid determines the hearing situation obtaining at the time. In accordance with the invention the sound field characteristic values generated in the first hearing aid are transmitted to the second hearing aid and preferably included with sound field characteristic values obtained in a similar manner in the second hearing aid jointly for determining the hearing situation and for creation of parameters to control signal processing in the second hearing aid. This is above all of interest if a useful sound source is active in an acoustic environment and if one hearing aid wearer is closer to the useful sound source than the other. The classifier of the hearing aid located closer to the sound source can then, because of the better signal-signal-to-noise ratio in his environment, create better and reliable estimated values relating to the current hearing situation and transmit these to at least one hearing aid of another hearing aid wearer, which is less able to reliably classify the current hearing situation. Subsequent methods, which need these classifier values can then operate better and thereby create a signal of better quality for the hearing aid wearer.

A further use in accordance with the invention provides for direct transmission of audio signals between the hearing aids of different hearing aid wearers. Although with this method, even if algorithms are used for data compression, very high data transmission rates are necessary; it does however have advantages if one hearing aid wearer is closer to the useful sound source than another and his hearing aid transmits the audio signal picked up—after processing it where necessary—to one or more further hearing aid wearers. In addition the first hearing aid wearer can himself or herself be the source of the useful sound and thus transmit his or her voice picked up by the microphone of his or her own first hearing aid with good signal -to-noise ratio as an audio signal to further hearing aid wearers.

Signals are preferably transmitted wirelessly between individual hearing aids. To this end the hearing aids feature the corresponding transceiver units. Signals are preferably transmitted bidirectionally so that each hearing aid of the hearing aid system can function as both a transmitter and a receiver. Furthermore, on transmission of control parameters when a bidirectional connection is used a correctly received signal will also be acknowledged.

With a further use in accordance with the invention there is provision for the hearing aid system to comprise more than two hearing aids which are worn by more than two hearing aid wearers. With this type of hearing aid system two different arrangements are possible. On one hand, for a first hearing aid and a second hearing aid located comparatively far from it, other hearing aids can be used to bridge the gap between the two aforementioned hearing aids. The intermediate hearing aids then perform similar functions to relay stations for radio connections. This therefore means that the signals are not transmitted directly from the first hearing aid to the second, but initially to a third hearing aid not located so far away, which then routes the received signals—where necessary via further hearing aids—to the second hearing aid located further away. This arrangement allows greater distances, e.g. in lecture halls, to be covered without any problems. It is recommended that signal transmission is based on a standardized transmission protocol, so that the hearing aid system can also include hearing aids from different manufacturers. An example of such a standard is Bluetooth.

A further option for using a hearing aid system with more than two users lies in improving the number of users and especially also in the distribution of the hearing aids in the room or the analysis options for the sound field concerned. The hearing aids of the users represent sensors for obtaining measurement data in the relevant sound field as it were. For example the sound field parameters obtained from the signal analyses in the individual hearing aids can be exchanged between the hearing aids so that in each hearing aid there is a comprehensive database present for the relevant sound field. From this data control parameters for control of signal processing in the relevant hearing aid can then be generated. In addition a master-slave arrangement is also conceivable, in which signals generated by the hearing aids of a number of hearing aid wearers (sound field characteristic values, audio signals) can be forwarded for further evaluation to a specific hearing aid (master). This can then if necessary determine the hearing program for all hearing aids of the hearing aid system. To this end the master hearing aid, from the forwarded signals and where necessary from data obtained in the master hearing aid itself, creates and sends a control signal for example, which is preferably forwarded wirelessly and determines signal processing or the hearing program in the slave hearing aids.

The manner in which a hearing aid of a hearing aid system used in accordance with the inventive system is incorporated into hearing aid system can preferably be determined by programming the relevant hearing aid with a programming device or by operating the hearing aid e.g. by means of a remote control. It is possible for example to determine here whether the relevant device involved is a master or a slave device, whether It merely sends data to the hearing aids of other hearing aid wearers or also receives data itself and whether where necessary influencing of the signal processing by control signals sent out by at least one hearing aid of at least one other hearing aid wearer are allowed or not. Likewise, with a hearing aid system used in accordance with the invention the communication options of two hearing aids can advantageously be defined for binaural provision of a hearing aid wearer. In principle there can be provision with both hearing aids for data transmission with at least one hearing aid of a further hearing aid wearer. However only one first hearing aid of a specific hearing aid wearer can be provided for data exchange with hearing aids of further hearing aid wearers, with the signal processing of the second hearing aid of the relevant hearing aid wearer then being controlled by the first hearing aid. Here too data is preferably transmitted wirelessly between the first and the second hearing aid.

### BRIEF DESCRIPTION OF THE DRAWINGS

The invention will be explained in more detail below with reference to an exemplary embodiment. The figures show:

FIG. 1 a hearing aid system according to the invention with three users,

FIG. 2 the hearing aids of the hearing aid system in a block diagram.

### DETAILED DESCRIPTION OF INVENTION

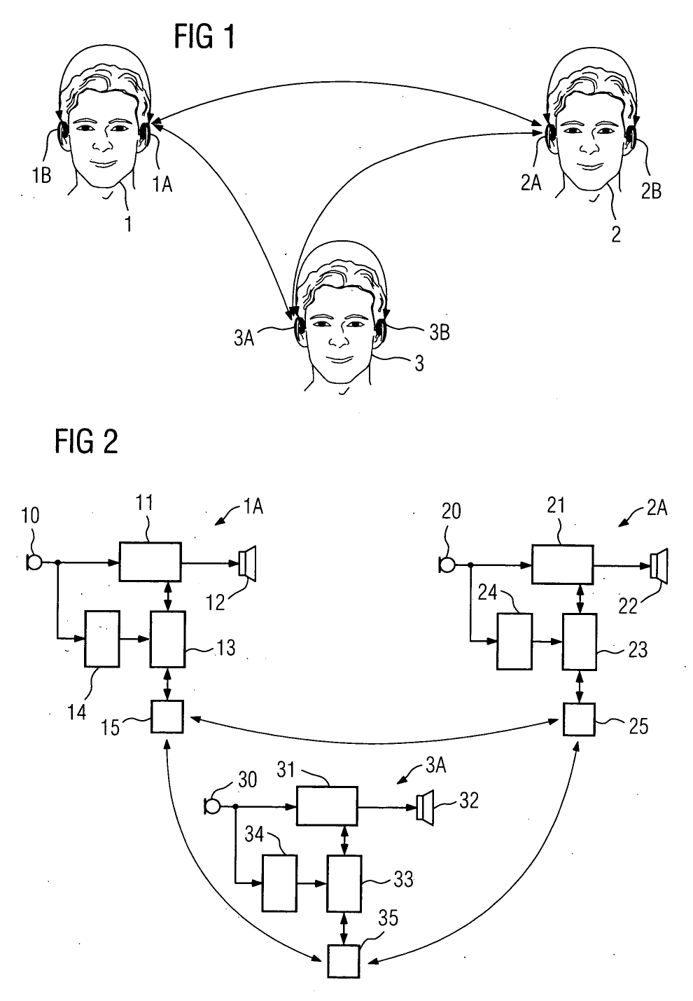

FIG. 1 shows three hearing aid wearers 1, 2 and 3, each supplied by two hearing aids 1A, 1B; 2A, 2B; 3A, 3B respectively. They are not at any great distance from each other, e.g. they are together in a room. The hearing aids of each hearing aid wearer possess a transmitter and receiver unit in each case for wireless signal transmission between the hearing aids of the relevant hearing aid wearer. This guarantee s that signal processing is matched in each case for the hearing aids of the relevant hearing aid wearer. For example the hearing aids of a hearing aid wearer are operated in the same hearing program in each case. In accordance with the invention data transmission between hearing aids is expanded to the extent that this is undertaken not only between the hearing aids of a hearing aid wearer but is expanded to a number of hearing aid wearers (users). In this case, in the exemplary embodiment, provision is included for signal transmission between hearing aids 1A and 2A as well as between hearing aids 1A and 3A. If for example hearing aid wearer 1 is in the immediate vicinity of a useful sound source, e.g. of a loudspeaker, a signal with a better signal-to-noise ratio can be received by hearing aid 1A than by hearing aids 2A and 3A. If the input signal received by hearing aid 1A—where necessary after further processing—is forwarded wirelessly as an audio signal wireless to hearing aids 2A and 3A, hearing aid wearers 2 and 3 also enjoy an output signal with a high signal-to-noise ratio. Interference signal sources in the immediate environment of hearing aid wearer 2 or 3 are no longer perceived as interference.

If the distance between the two hearing aids 1A and 2A is so large that a direct wireless signal transmission between these two hearing aids is not possible, the signal can also be transmitted from hearing aid 1A to hearing aid 2A by way of hearing aid 3A, which is located approximately between the two hearing aids 1A and 2A. Hearing aid 3A thus takes over the function of a relay station for signal transmission from hearing aid 1A to hearing aid 2A. Where necessary in this case different carrier frequencies of the carrier signals for the signals sent by hearing aid 1A and hearing aid 3A are to be used, as is generally known for the use of relay stations from radio technology.

The hearing aid system used in accordance with the invention offers a plurality of variation options. In the exemplary embodiment all three hearing aid wearers are supplied binaurally, i.e. by two hearing aids each. However only one hearing aid 1A, 2A or 3A is embodied for communication with a hearing aid of another hearing aid wearer. In order to still guarantee binaural provision with one output signal with a good signal-to-noise ratio, the transmitted signals are forwarded from hearing aid 2A to hearing aid 2B or from hearing aid 3A to hearing aid 3B. In this case it is also possible that hearing aid 1B also receives an acoustic input signal which is then forwarded to hearing aid 1A and from there, just like the signal received by hearing aid 1A, to hearing aid 2A or 3A. Then, after receipt the signal accepted at the right ear of the hearing aid wearer 1 by hearing aid 1B can be routed in each case to the right ear of the hearing aid wearer 2 or 3. The system behaves in the same way with the signal received at the left ear of the hearing aid wearer 1 by hearing aid 1A. Although this method of operation demands a very high data transmission rate between the individual hearing aids the spatial hearing effect is retained here.

In the arrangement shown in FIG. 1 hearing aid wearers 2 and 3 can preferably switch between the audio signal emitted from hearing aid 1A and the signals obtained from the microphone signals of the hearing aid 2A, 2B or 3A, 3B. In addition it is also possible for the signals originating from the different sources to be weighted and added. Thus example the output signals from the small microphones of hearing aids 2A and 2B can be mixed in each case to an audio signal originating from hearing aid 1A or 1B in a variable weighting system.

The transmission of audio signals between hearing aids of different hearing aid wearers described above represents a high-end solution which requires a very high data transmission rate between the individual hearing aids. With a less expensive variant only control signals are transmitted between the individual hearing aids of the different hearing aid wearers. Assuming that the hearing aid wearer 1 is again in the immediate vicinity of a useful signal source, hearing aid 1A can for example best generate filter parameters for adapting the signal processing to this signal source, which are then transmitted on the transmission path already described for the audio signal to the other hearing aids 2A, 2B; or 3A, 3B, so that the appropriate filter settings can also be made at these hearing aids.

With an alternative embodiment the signal transmission between hearing aids of a number of hearing aid wearers is used to analyze more precisely the hearing environment (the sound field), in which the hearing aid wearers are located than would be possible for an individual hearing aid wearer. For each hearing aid wearer 1, 2 and 3 sound field characteristic values are generated for each hearing aid 1A, 2A . 3A from the input signals in the hearing aid, which are then included for classification of the sound field. Advantageously in this case there is an exchange between hearing aids 1A, 2A and 3A as regards the sound field characteristic values generated in the relevant hearing aids. Overall this provides a higher number of sound field characteristic values, which then especially contain more information regarding the spatial distribution of the interference and useful signal sources in the relevant sound field. This enables an improved automatic adaptation of the hearing aids 1A, 1B, 2A, 2B, 3A and 3B to be achieved at the relevant sound field.

For the invention at least two hearing aids, which are worn by different hearing aid wearer, are required. The hearing aid system used in accordance with the invention can however be expanded to almost any number of users. Furthermore in the exemplary embodiment there is binauaral provision for each hearing aid wearer 1, 2 or 3 with two hearing aids 1A, 1B; 2A, 2B; 3A, 3B in each case, with only one hearing aid communicating in each case with the two hearing aids of the other hearing aid wearer and to match the two hearing aids of a hearing aid wearer there is provision for a separate data exchange between the two relevant hearing aids. Of course an arrangement would be possible in which all (in the exemplary embodiment 6) hearing aids communicate directly with one another.

FIG. 2 shows the three hearing aids 1A, 2A and 3A of the hearing aid system according to FIG. 1 in a simplified block diagram. Each of the hearing aids possesses a microphone 10, 20 or 30 for accepting an acoustic input signal and converting it into an electrical signal. Downstream from the microphone in case a signal processor 11, 21 or 31 is provided for processing and frequency-dependent amplification of the relevant input signal and for compensating for the individual hearing loss of the hearing aid wearer 1, 2 or 3. The processed signal is finally converted back in each case by means of an earpiece 12, 22 or 32 into an acoustic signal and in emitted in an auditory canal of the hearing aid wearer 1, 2 or 3. Each of the hearing aids 1A, 2A . 3A further comprises a signal analysis unit 14, 24 or 34 for analyzing the electrical input signal. For the signal analysis sound field characteristic values are gene rated, relating for example to the relevant signal level, the frequency spectrum, the modulation frequencies, the modulation depths, interference components or sound field characteristic values, such as coherence, incident direction of interference or useful signals etc. From the sound field characteristic values parameters are generated in the control unit 13, 23 or 33 for adapting signal processing in the signal processing units 11, 21 or 31. In addition, by means of the transceiver units 15, 25 or 35 there is an exchange of the sound field characteristic values obtained in the hearing aids 1A, 2A and 3A between the individual hearing aid wearers. The transmitted sound field characteristic values are also used in the signal processing units 13, 23 and 33 to optimize the setting of the parameters for control of the signal processing in the signal processors 11,21 and 31.

As an alternative to the sound field characteristic values, control parameters can also be transmitted between the individual hearing aids, in order especially to adapt the signal processing in the individual hearing aids to each other. Thus for example all hearing aids 1A, 2A and 3A can be matched by operating the same hearing program.

A further alternative of the invention consists of transmitting via the transceiver units 15, 25 or 35 audio signals stemming directly from the microphone signals of the relevant hearing aid 1A, 2A or 3A between individual hearing aid wearers. If for example an audio signal of hearing aid 1A is transmitted via transceiver unit 15 to hearing aid 2A and received by the transceiver unit 25 this can be routed using a weighting which can be set via the control unit 23 to the signal processing unit 21 and thereby mixed with the signal coming from the microphone 20.

Naturally the invention is not restricted to the alternatives described. Instead, with a hearing aid system according to the invention it is also possible for both the control signals and the sound field characteristic values to also be transmitted as audio signals between the hearing aids.

Furthermore master-slave operation is also possible, in which one hearing aid (e.g. 3A) is given a higher-ranking function compared to the other hearing aids (e.g. 1A, 2A). For example all three hearing aids can in this way generate sound field characteristic values from the relevant acoustic input signal, with the sound field characteristic values generated by the hearing aids 1A and 2A being transmitted for further analysis to hearing aid 3A. Hearing aid 3A then creates from the sound field characteristic values generated in all three hearing aids 1A, 2A, 3A control parameters for adapting signal processing in the hearing aids 1A, 2A, 3A. Corresponding control signals are then transmitted by hearing aid 3A to hearing aids 1A and 2A.

1.-9. (canceled)

10. A method of operating a hearing aid system having at least first and second hearing aids configured to be worn on the head or the body of a hearing aid user, the first and second hearing aids each comprising:
at least one input converter for acquiring an input signal and converting the input signal into an electrical input signal;
a signal processing unit for processing and amplifying the electrical input signal; and
an output converter for emitting an acoustic output signal perceivable by the hearing aid user, the method comprising transmitting control parameters from the first hearing aid to the second hearing aid for controlling a signal processing mechanism implemented in the second hearing, wherein the first and second hearing aids are worn by different hearing aid users during said transmitting of the control parameters.

11. A method of operating a hearing aid system having at least first and second hearing aids configured to be worn on the head or the body of a hearing aid user, the first and second hearing aids each comprising:
at least one input converter for acquiring an input signal and converting the input signal into an electrical input signal;
a signal processing unit for processing and amplifying the electrical input signal; and
an output converter for emitting an acoustic output signal perceivable by the hearing aid user, the method comprising:
acquiring the input signal by the first hearing aid;
analyzing the acquired input signal by the first hearing aid;
determining first sound field characteristic values based on the analyzed input signal by the first hearing aid;
transmitting the determined first sound field characteristic values from the first to the second hearing aid;
determining first control parameters by the first hearing aid;
transmitting the first control parameters from the first to the second hearing aid;
determining second control parameters based on the transmitted first sound field characteristic values by the second hearing aid; and
adjusting the signal processing unit of the second hearing aid based on the second control parameters, wherein the first and second hearing aids are worn by different hearing aid users during said determining and transmitting of the sound field characteristic values from the first to the second hearing aid.

12. The method in accordance with claim 11, further comprising:
acquiring the input signal by the second hearing aid;
analyzing the acquired input signal by the second hearing aid; and
determining second sound field characteristic values by the second hearing aid based on the input signal acquired by the second hearing aid, wherein determining the second control parameters is further based on the determined second sound field characteristic values.

13. A method of operating a hearing aid system having at least first and second hearing aids configured to be worn on the head or the body of a hearing aid user, the first and second hearing aids each comprising:
at least one input converter for acquiring an input signal and converting the input signal into an electrical input signal;
a signal processing unit for processing and amplifying the electrical input signal; and
an output converter for emitting an acoustic output signal perceivable by the hearing aid user, the method comprising:
transmitting an audio signal from the first to the second hearing aid; and
emitting the transmitted audio signal or an audio signal derived from the transmitted audio signal by the output converter of the second hearing aid, wherein the first and second hearing aids are worn by different hearing aid users during said transmission of the audio signal or the derived audio signal.

14. The method in accordance with claim 13, wherein prior to emitting the transmitted audio signal by the second hearing aid, the transmitted audio signal is processed by the second hearing aid using a signal processing mechanism implemented in the second hearing aid.

15. The method in accordance with claim 13, further comprising generating a mix signal by the second hearing aid based on the audio signal transmitted from the first hearing aid to the second hearing aid and the input signal acquired by the second hearing aid.

16. The method in accordance with claim 13, further comprising generating a mix signal by the second hearing aid based on the derived audio signal and the input signal acquired by the second hearing aid.

17. The method in accordance with any of claims 10, 11 and 13, wherein a third hearing aid is worn on the head or the body of a third hearing aid user and signals to be transmitted from the first to the second hearing aid are transmitted from the first to the third hearing aid, amplified by the third hearing aid and transmitted from the third hearing aid to the second hearing aid, the third hearing aid comprising:
at least one input converter for acquiring an input signal and converting the input signal into an electrical input signal;
a signal processing unit for processing and amplifying the electrical input signal; and
an output converter for emitting an acoustic output signal perceivable by the hearing aid user.

18. The method in accordance with any of claims 10, 11 and 13, wherein signal transmission between the hearing aids is executed wirelessly.

19. The method in accordance with any of claims 10, 11 and 13, wherein the hearing aids are configured to transmit signals bi-directionally between the hearing aids.
